(19) United States
(12) Patent Application Publication
(10) Pub. No.: US 2019/0104882 A1
(43) Pub. Date: Apr. 11, 2019

(54) EASY UNLOADING HIGH PRESSURE COFFEE BREWING MACHINE WITH FOAM CREATION FUNCTION

(71) Applicant: Kin Wai NG, Hong Kong (HK)

(72) Inventor: Kin Wai NG, Hong Kong (HK)

(21) Appl. No.: 15/839,832

(22) Filed: Dec. 12, 2017

(30) Foreign Application Priority Data
Oct. 9, 2017 (CN) 201710929848.6

(51) Int. Cl. A47J 31/44; A47J 31/36

(52) U.S. Cl. CPC A47J 31/4496; A47J 31/3604

(57) ABSTRACT

The present invention relates to an easy unloading high pressure coffee brewing machine with foam creation function, comprises an installation stand for connection to the environment, a brewing bucket, an unloading mechanism, a pressurizing mechanism and a foam creation mechanism, the brewing bucket has a double open-ended structure; the unloading mechanism is disposed at the bottom opening of the brewing bucket, the unloading mechanism comprises an unloading plate, a funnel; the pressurizing mechanism is disposed at the top opening of the brewing bucket, the pressurizing mechanism comprises a platen, a pressurizing cover; the foam creation mechanism comprises a sleeve opened at two ends, a filter basket sleeved onto the top of the inside of the sleeve, a foamer mesh cover sleeved to a bottom of the inside of the sleeve, an air pump; the structure is reasonable, having advantages of simple, convenient, has multiple functions, unloading is convenient, and good brewing performance, effectively solving the problem of brewing mechanisms of existing coffee machines being hard to unload dreg and cannot produce large amount of foam.

### FIELD OF INVENTION

The present invention relates to the field of coffee machines, in particular to an easy unloading high pressure coffee brewing machine with foam creation function.

### BACKGROUND OF INVENTION

Presently, coffee machines usually puts coffee powder, coffee cakes or coffee capsules directly into the coffee machine for brewing, but most brewing devices for coffee machines uses a fixed container for holding coffee raw material, used coffee dreg is hard to be removed from the coffee brewing device; during brewing, with inflow of hot water, coffee raw material becomes loose, flow speed of hot water varies a lot and affects the strength and richness of the coffee; furthermore normal coffee brewing devices only holds and brews coffee raw material, and do not have a coffee foaming function, so need to be separately performed if rich foam is needed, so is cumbersome. Therefore an easy unloading high pressure coffee brewing machine with foam creation function is desired.

In existing technology, cutting and cropping of soft fabric and paper utilizes separate cutting tools and rulers. While they achieve the function of cutting the raw material, the cutting tool is not fixed during the cutting operation, and may cut the hand pressing on the ruler if not paying attention. The cutting tool is limited by the flatness of the operating platform, combining with operation errors, will easily produce nonstraight cuts. Furthermore, limited by the length of the ruler, cutting of lengthy raw materials needs large scale cutting equipment. On the other hand, existing rulers cannot perform accurate cuts in angle and length, and can only cut edges one by one. Therefore a cutting ruler that is reliable, convenient for storage, easy positioning, high accuracy and can also cut two edges at the same time is desired.

### SUMMARY OF INVENTION

The technical problem to be solved by the present invention is: to overcome the aforementioned problem, an easy unloading high pressure coffee brewing machine with foam creation function is provided. The structure is reasonable, having advantages of simple, convenient, has multiple functions, unloading is convenient, and good brewing performance, effectively solving the problem of brewing mechanisms of existing coffee machines being hard to unload dreg and cannot produce large amount of foam.

The technical solution used in the present invention to solve the technical problem is: an easy unloading high pressure coffee brewing machine with foam creation function comprises an installation stand for connection to the environment, a brewing bucket, an unloading mechanism, a pressurizing mechanism and a foam creation mechanism, the brewing bucket has a double open-ended structure, an annular groove is disposed at a bottom of the inside wall of the brewing bucket, a number of first protrusions is uniformly disposed around the annular groove, an external thread is disposed at an upper part of the outside wall of the brewing bucket, a number of guide rails are vertically disposed at the inside wall of the brewing bucket; the installation stand is connected to the brewing bucket through a crank;

The unloading mechanism is disposed at the bottom opening of the brewing bucket, the unloading mechanism comprises an unloading plate, a funnel, the unloading plate is connected to the entrance end of the funnel, a number of first through holes is disposed at overlapping areas between the central part of the unloading plate and the entrance of the funnel; a number of second protrusions is radially uniformly disposed on the unloading plate, the first protrusion and the second protrusion are sleeved to unloading spring respectively;

The pressurizing mechanism is disposed at the top opening of the brewing bucket, the pressurizing mechanism comprises a platen, a pressurizing cover; the platen comprises an upper platen, a lower platen, the upper platen and the lower platen are threadedly connected and forms a first chamber; a water pipe connected to the first chamber and a first magnetic plate is disposed on the upper platen; a number of second through holes is disposed at a bottom of the lower platen, the side wall of the lower platen is latched to a flexible loop for releasing pressure;

An internal thread corresponding to the external thread, and a second magnetic plate symmetric to the first magnetic plate is disposed at an internal chamber of the pressurizing cover, a third through hole is disposed on the pressurizing cover, the water pipe is sleeved to the third through hole; the polarities at the faces of first magnetic plate and the second magnetic plate facing each other are the same, the second magnetic plate is embedded to an internal chamber of the pressurizing cover, the second magnetic plate can be removed and replaced;

The foam creation mechanism comprises a sleeve opened at two ends, a filter basket sleeved onto the top of the inside of the sleeve, a foamer mesh cover sleeved to a bottom of the inside of the sleeve, an air pump; the sleeve is connected to the exit of the funnel; a number of conical through holes is disposed at a bottom of the filter basket, a filter paper is disposed inside the filter basket; an air pipe is disposed at the sleeve between the filter basket and the foamer mesh cover for connecting the same, the air pipe is connected to the air pump fixedly disposed on the brewing bucket.

In a further embodiment, a first guide notch is disposed on the unloading plate.

In a further embodiment, a sealing pad is disposed at a connecting area between the unloading plate and the funnel.

In a further embodiment, a micro water pump is disposed on the water pipe for pressurizing, the micro water pump is connected to the coffee machine hot water tank.

In a further embodiment, the water pipe and the upper platen is made in one piece.

In a further embodiment, the flexible loop is made of soft rubber or made of a resilient band disposed with soft fiber, a second guide notch is disposed on the flexible loop.

In a further embodiment, the air pump, the micro water pump is electrically connected to the controller of the coffee machine respectively.

The advantage of the present invention is: the easy unloading high pressure coffee brewing machine with foam creation function of the present invention, comprises an installation stand for connection to the environment, a brewing bucket, an unloading mechanism, a pressurizing mechanism and a foam creation mechanism; the installation stand is connected to the brewing bucket through a crank, when in use the brewing bucket can extend outwards for adding coffee raw material or return to an operating position under the action of the crank, and does not need to be uninstalled repeatedly, therefore is convenient to use; the unloading mechanism disposed at the bottom of the brewing bucket can push the coffee dreg upwards, achieving fast and convenient unloading; the pressurizing mechanism disposed at the top opening of the brewing bucket can keep the coffee raw material pressed, ensuring flow speed of water stream to affect coffee strength, at the same time the second magnetic plate can be replaced to adjust the pressing force and in turn adjust coffee strength; brewed coffee is mixed with pressurized air pumped from the air pump, and passes through the foamer mesh cover at high speed to product rich foam; the structure is reasonable, having advantages of simple, convenient, has multiple functions, unloading is convenient, and good brewing performance, effectively solving the problem of brewing mechanisms of existing coffee machines being hard to unload dreg and cannot produce large amount of foam.

### BRIEF DESCRIPTION OF DRAWINGS

The present invention is further explained below with the accompanying drawings and embodiments.

FIG. 1 is an overall structural schematic diagram of an easy unloading high pressure coffee brewing machine with foam creation function according to the present invention.

FIG. 2 is a cross section schematic diagram of a brewing bucket of an easy unloading high pressure coffee brewing machine with foam creation function according to the present invention.

FIG. 3 is a cross section schematic diagram of an unloading mechanism of an easy unloading high pressure coffee brewing machine with foam creation function according to the present invention.

FIG. 4 is a structural schematic diagram of a platen of an easy unloading high pressure coffee brewing machine with foam creation function according to the present invention.

FIG. 5 is a structural schematic diagram of a pressurizing cover of an easy unloading high pressure coffee brewing machine with foam creation function according to the present invention.

FIG. 6 is a structural schematic diagram of a foam creation mechanism of an easy unloading high pressure coffee brewing machine with foam creation function according to the present invention.

Reference numbers in the drawings: 1 installation stand, 11 crank, 2 brewing bucket, 21 unloader spring, 22 external thread, 23 annular groove, 24 first protrusion, 25 guide rail, 3 unloading mechanism, 311 first through hole, 312 first guiding notch, 313 second protrusion, 32 funnel, 321 sealing pad, 4 pressurizing mechanism, 41 platen, 411 micro pump, 412 first magnetic plate, 413 water pipe, 414 upper platen, 415 lower platen, 4151 second through hole, 416 flexible loop, 417 first chamber, 42 pressurizing cover, 421 second magnetic plate, 422 third through hole, 423 internal thread, 5 foam creation mechanism, 51 pump, 52 sleeve, 53 filter basket, 531 handle, 54 filter paper, 55 foamer mesh cover, 56 air pipe.

### DETAILED DESCRIPTION OF INVENTION

The present invention is further explained below along with the accompanying drawings. The drawings are all simplified schematic diagrams which only illustrates the basic structure of the present invention, as such only the components raw material to the present invention are shown.

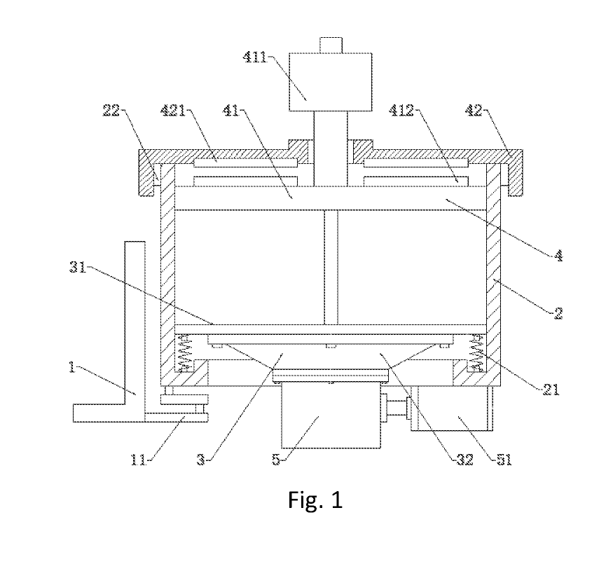

As shown in FIG. 1, an easy unloading high pressure coffee brewing machine with foam creation function comprises an installation stand 1 for connection to the environment, a brewing bucket 2, an unloading mechanism 3, a pressurizing mechanism 4 and a foam creation mechanism 5.

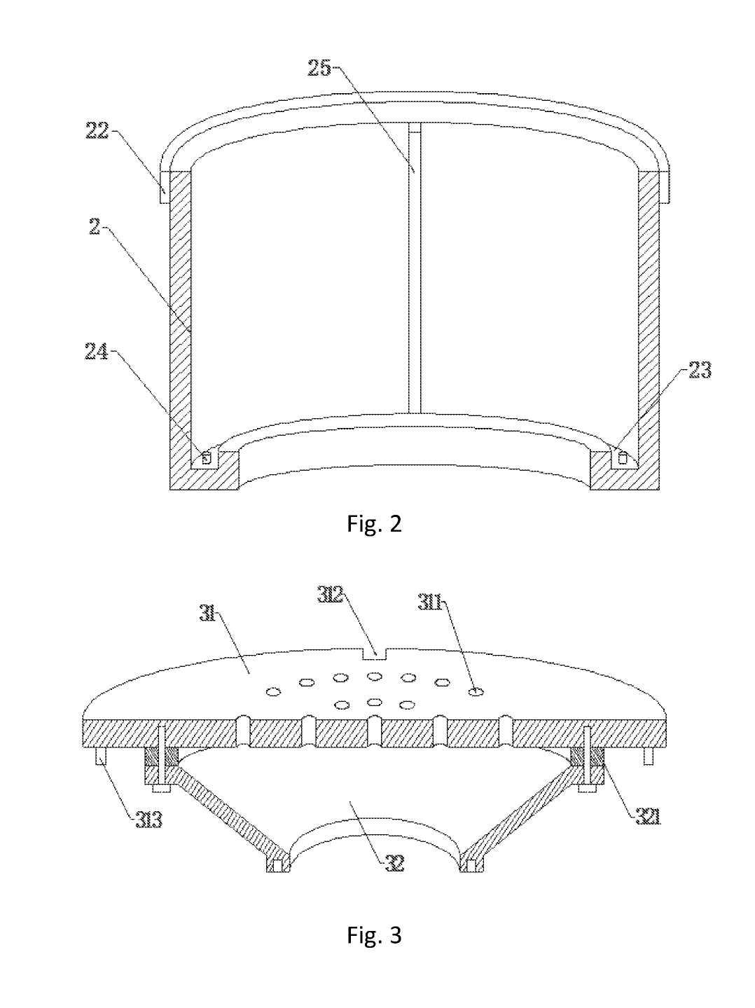

As shown in FIG. 2, the brewing bucket 2 has a double open-ended structure, an annular groove 23 is disposed at a bottom of the inside wall of the brewing bucket 2, a number of first protrusions 24 is uniformly disposed around the annular groove 23, an external thread 22 is disposed at an upper part of the outside wall of the brewing bucket 2, a number of guide rails 25 are vertically disposed at the inside wall of the brewing bucket 2; the installation stand 1 is connected to the brewing bucket 2 through a crank 11, when in use the brewing bucket can extend outwards for adding coffee raw material or return to an operating position under the action of the crank, and does not need to be uninstalled repeatedly, therefore is convenient to use.

As shown in FIG. 3, the unloading mechanism 3 is disposed at the bottom opening of the brewing bucket 2, the unloading mechanism 3 comprises an unloading plate 31, a funnel 32, the unloading plate is connected to the entrance end of the funnel 32, a number of first through holes 311 is disposed at overlapping areas between the central part of the unloading plate 31 and the entrance of the funnel 32; a number of second protrusions 313 is radially uniformly disposed on the unloading plate 31, the first protrusion 24 and the second protrusion 313 are sleeved to unloading spring 21 respectively; a first guide notch 312 slidably connected to the guide rail 25 is disposed on the unloading plate 31, preventing the unloading plate 31 to rotate and dislodge from the unloading spring 21 when moving up and down.

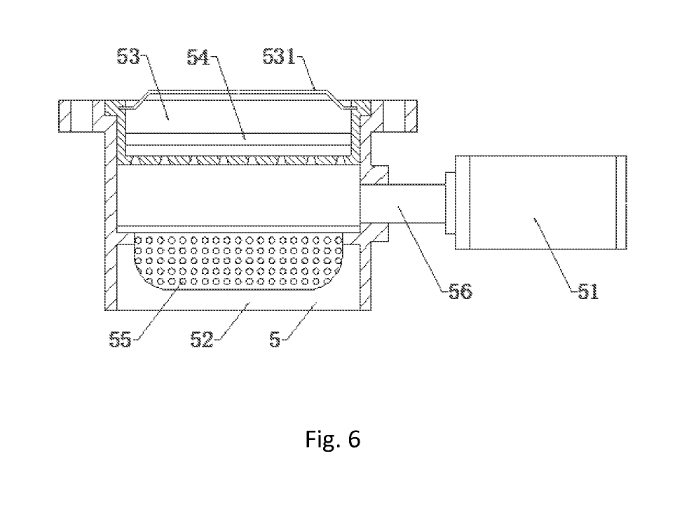

As shown in FIGS. 1, 4 and 5, the pressurizing mechanism 4 is disposed at the top opening of the brewing bucket 2, the pressurizing mechanism 4 comprises a platen 41, a pressurizing cover 42; the platen 41 comprises an upper platen 414, a lower platen 415, the upper platen 414 and the lower platen 415 are threadedly connected and forms a first chamber 417; a water pipe 413 connected to the first chamber 417 and a first magnetic plate 412 is disposed on the upper platen 414; a number of second through holes 4151 is disposed at a bottom of the lower platen 415, the side wall of the lower platen 415 is latched to a flexible loop 416 for releasing pressure;

An internal thread 423 corresponding to the external thread 22, and a second magnetic plate 421 symmetric to the first magnetic plate 412 is disposed at an internal chamber of the pressurizing cover 42, a third through hole 422 is disposed on the pressurizing cover 42, the water pipe 413 is sleeved to the third through hole 422.

As shown in FIG. 6, the foam creation mechanism 5 comprises a sleeve 52 opened at two ends, a filter basket 53 sleeved onto the top of the inside of the sleeve 52, a foamer mesh cover 55 sleeved to a bottom of the inside of the sleeve, an air pump 51; the sleeve is connected to the exit of the funnel 32; a number of conical through holes is disposed at a bottom of the filter basket 53, a filter paper 54 is disposed inside the filter basket 53; an air pipe 56 is disposed at the sleeve 52 between the filter basket 53 and the foamer mesh cover 55 for connecting the same, the air pipe 56 is connected to the air pump 51 fixedly disposed on the brewing bucket 2. The conical through holes causes the coffee liquid to be in a stream when poured, allowing the coffee liquid to mix better with the air pumped from the air pump 51, pressurized coffee and air mixture through the air pump 51 and the micro water pump 411 passes through the foamer mesh cover 55 in a high speed, and collides with the foamer mesh cover 55 to produce a large amount of foam.

In an embodiment as shown in FIG. 6, a handle 531 is hinged to the filter basket 53 for convenient removal of the filter basket 53.

In an embodiment as shown in FIG. 3, a sealing pad 321 is disposed at a connecting area between the unloading plate 31 and the funnel 321, therefore preventing leaking of coffee liquid. In another possible embodiment, an annular protrusion and an annular groove corresponding to the annular protrusion is disposed at the connection areas of the unloading plate 31 and the funnel 32 respectively, the annular protrusion and the annular groove combines to prevent leaking of coffee liquid.

In an embodiment as shown in FIG. 1, a micro water pump 411 is disposed on the water pipe 413 for pressurizing, the micro water pump 411 is connected to the coffee machine hot water tank, the micro water pump 411 pressurizes the brewing bucket 2, preventing a pressure difference building up in a chamber between the foamer mesh cover 55 and the filter basket 53, causing coffee liquid unable to flow out.

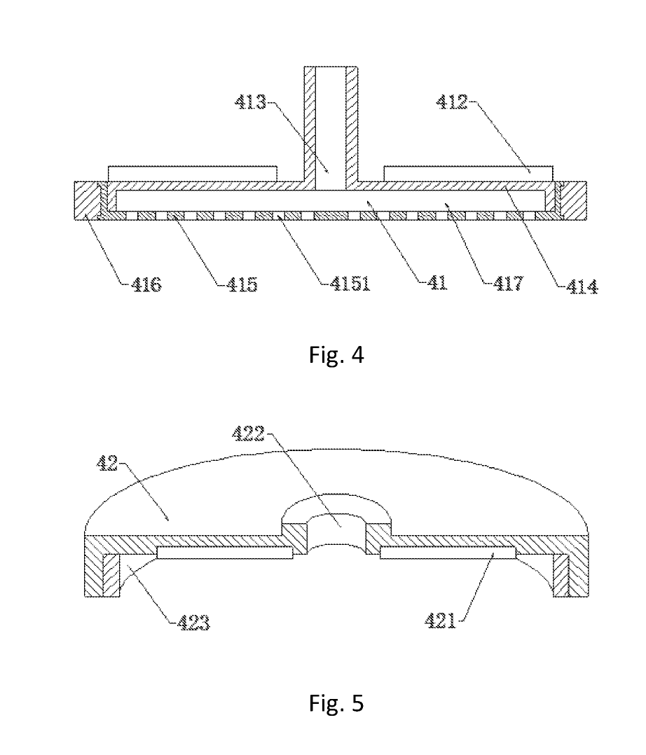

In an embodiment as shown in FIG. 4, the water pipe 413 and the upper platen 414 is made in one piece.

In an embodiment as shown in FIG. 4, the flexible loop 416 is made of soft rubber. In another embodiment the flexible loop 416 is made of a resilient band disposed with soft fiber.

The polarities at the faces of first magnetic plate 412 and the second magnetic plate 421 facing each other are the same, ensuring a repulsion force to be produced between the first magnetic plate 412 and the second magnetic plate 421, pushing the platen 41 downwards to tightly press on the coffee raw material.

In an embodiment, the second magnetic plate 421 is embedded to an internal chamber of the pressurizing cover 42, the second magnetic plate 421 can be removed and replaced, in order to adjust the repulsion force between the second magnetic plate 421 and the first magnetic plate 412.

A second notch is disposed on the flexible loop 416 for slidably connecting to the guide rail 25, preventing the platen 41 to rotate when moving up and down, thereby causing the first magnetic plate 412 to displace from the second magnetic plate 421 and losing the repulsion force.

The air pump 51, the micro water pump 411 is electrically connected to the controller of the coffee machine respectively, the controller controls the air pump 51 and the micro water pump 411 to switch on or off respectively.

The easy unloading high pressure coffee brewing machine with foam creation function of the present invention, comprises an installation stand for connection to the environment, a brewing bucket, an unloading mechanism, a pressurizing mechanism and a foam creation mechanism; the installation stand is connected to the brewing bucket through a crank, when in use the brewing bucket can extend outwards for adding coffee raw material or return to an operating position under the action of the crank, and does not need to be uninstalled repeatedly, therefore is convenient to use; the unloading mechanism disposed at the bottom of the brewing bucket can push the coffee dreg upwards, achieving fast and convenient unloading; the pressurizing mechanism disposed at the top opening of the brewing bucket can keep the coffee raw material pressed, ensuring flow speed of water stream to affect coffee strength, at the same time the second magnetic plate can be replaced to adjust the pressing force and in turn adjust coffee strength; brewed coffee is mixed with pressurized air pumped from the air pump, and passes through the foamer mesh cover at high speed to product rich foam; the structure is reasonable, having advantages of simple, convenient, has multiple functions, unloading is convenient, and good brewing performance, effectively solving the problem of brewing mechanisms of existing coffee machines being hard to unload dreg and cannot produce large amount of foam.

As revealed by the preferred embodiments of the present invention, based on the aforementioned description, a person skilled in the art can make various modifications and adjustments without departing from the technical concept of the present invention. The technical scope of the present invention is not limited to the specification but is defined by the scope of the claims.

What is claimed is:

1. An easy unloading high pressure coffee brewing machine with foam creation function, comprises an installation stand for connection to the environment, a brewing bucket, an unloading mechanism, a pressurizing mechanism and a foam creation mechanism, the brewing bucket has a double open-ended structure, an annular groove is disposed at a bottom of the inside wall of the brewing bucket, a number of first protrusions is uniformly disposed around the annular groove, an external thread is disposed at an upper part of the outside wall of the brewing bucket, a number of guide rails are vertically disposed at the inside wall of the brewing bucket; the installation stand is connected to the brewing bucket through a crank;
the unloading mechanism is disposed at the bottom opening of the brewing bucket, the unloading mechanism comprises an unloading plate, a funnel, the unloading plate is connected to the entrance end of the funnel, a number of first through holes is disposed at overlapping areas between the central part of the unloading plate and the entrance of the funnel; a number of second protrusions is radially uniformly disposed on the unloading plate, the first protrusion and the second protrusion are sleeved to unloading spring respectively;
the pressurizing mechanism is disposed at the top opening of the brewing bucket, the pressurizing mechanism comprises a platen, a pressurizing cover; the platen comprises an upper platen, a lower platen, the upper platen and the lower platen are threadedly connected and forms a first chamber; a water pipe connected to the first chamber and a first magnetic plate is disposed on the upper platen; a number of second through holes is disposed at a bottom of the lower platen, the side wall of the lower platen is latched to a flexible loop for releasing pressure;
an internal thread corresponding to the external thread, and a second magnetic plate symmetric to the first magnetic plate is disposed at an internal chamber of the pressurizing cover, a third through hole is disposed on the pressurizing cover, the water pipe is sleeved to the third through hole; the polarities at the faces of first magnetic plate and the second magnetic plate facing each other are the same, the second magnetic plate is embedded to an internal chamber of the pressurizing cover, the second magnetic plate can be removed and replaced;
the foam creation mechanism comprises a sleeve opened at two ends, a filter basket sleeved onto the top of the inside of the sleeve, a foamer mesh cover sleeved to a bottom of the inside of the sleeve, an air pump; the sleeve is connected to the exit of the funnel; a number of conical through holes is disposed at a bottom of the filter basket, a filter paper is disposed inside the filter basket; an air pipe is disposed at the sleeve between the filter basket and the foamer mesh cover for connecting the same, the air pipe is connected to the air pump fixedly disposed on the brewing bucket.

2. The easy unloading high pressure coffee brewing machine with foam creation function according to claim 1, characterized in that: a first guide notch is disposed on the unloading plate.

3. The easy unloading high pressure coffee brewing machine with foam creation function according to claim 1, characterized in that: a sealing pad is disposed at a connecting area between the unloading plate and the funnel.

4. The easy unloading high pressure coffee brewing machine with foam creation function according to claim 1, characterized in that: a micro water pump is disposed on the water pipe for pressurizing, the micro water pump is connected to the coffee machine hot water tank.

5. The easy unloading high pressure coffee brewing machine with foam creation function according to claim 1, characterized in that: the water pipe and the upper platen is made in one piece.

6. The easy unloading high pressure coffee brewing machine with foam creation function according to claim 1, characterized in that: the flexible loop is made of soft rubber or made of a resilient band disposed with soft fiber, a second guide notch is disposed on the flexible loop.

7. The easy unloading high pressure coffee brewing machine with foam creation function according to claim 1, characterized in that: the air pump, the micro water pump is electrically connected to the controller of the coffee machine respectively.
